(19) United States
(12) Patent Application Publication
(10) Pub. No.: US 2012/0032923 A1
(43) Pub. Date: Feb. 9, 2012

(54) INFRARED CONTROLLING DEVICE

(75) Inventors: FAN-LIN LU, Shenzhen City (CN); XIN ZHAO, Shenzhen City (CN); RUEY-SHYANG YOU, Tu-Cheng (TW); XIAO-GUANG LI, Shenzhen City (CN); HAN-CHE WANG, Tu-Cheng (TW); KUAN-HONG HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/076,446

(22) Filed: Mar. 31, 2011

(30) Foreign Application Priority Data
Aug. 6, 2010 (CN) 201010247533.1

(51) Int. Cl. G06F 3/042

(52) U.S. Cl. 345/175

(57) ABSTRACT

An IR controlling device includes a display panel, a number of IR emitters, a number of IR receivers, and a receiving controller. The IR emitters and the IR receivers are staggered under the display panel, and facing the display panel. The IR emitters are to emit IR beams in sequence, and the IR receivers are to receive the IR beams reflected by an external object. The receiving controller generates a plurality of response signals corresponding to the IR receivers. An IR processing unit receives the response signals, and determines a virtual position of the external object on the display panel. A controlling unit outputs a control signal and executes a corresponding function. A display processing unit receives the control signal and updates the content on the display panel.

### BACKGROUND

1. Technical Field

The present disclosure relates to an infrared (IR) controlling device.

2. Description of Related Art

A typical IR touch device, includes a number of IR emitters and a number of receivers distributed on the edges of a screen of the IR touch device. Infrared rays emitted by the IR emitters transmit on the surface of the screen. With such structure, a space must be reserved in the IR touch device for transmitting the infrared rays. However, the structure of the IR touch device cannot satisfy the requirements for the trend towards miniaturization. Furthermore, when user touches the screen to input commands they will leave dirt or smears on the screen, which will shorten the service life of the IR touch device.

Therefore, what is needed is an IR controlling device to overcome the shortcomings of the above-mentioned typical IR touch device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an IR controlling device according to an embodiment.

FIG. 2 is a schematic view of an arrangement of a number of IR emitters and IR receivers of the IR controlling device of FIG. 1.

FIG. 3 is a partial, side schematic view of the IR controlling device of FIG. 1.

### DETAILED DESCRIPTION

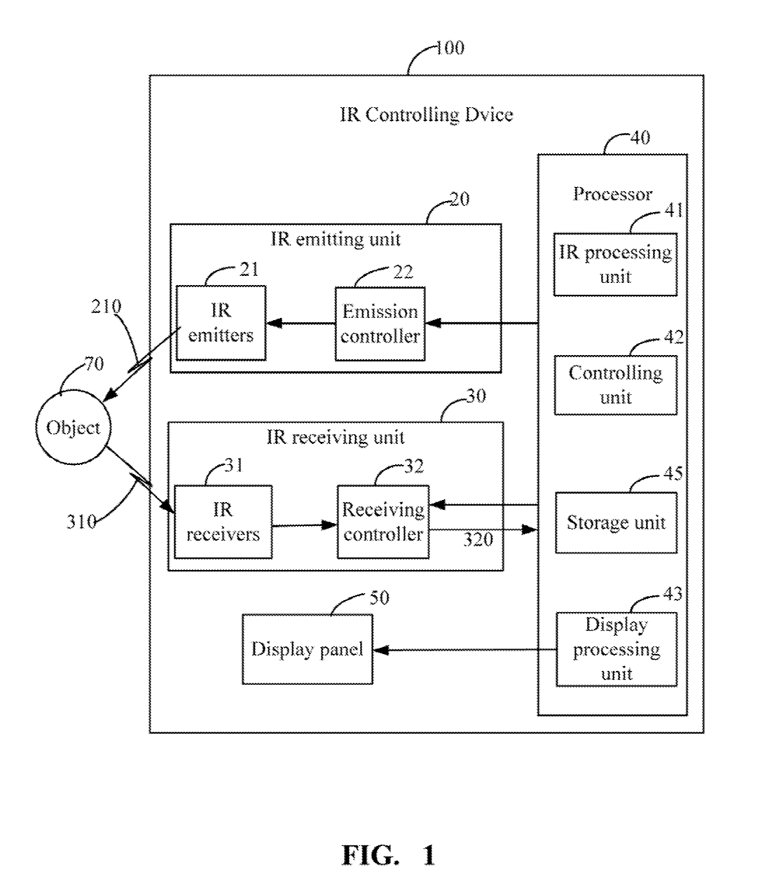

Referring to FIG. 1, an IR controlling device 100 is illustrated. The IR controlling device 100 includes an IR emitting unit 20, an IR receiving unit 30, a processor 40 and a display panel 50. The IR controlling device 100 can be applied to a number of electronic devices, such as E-books, computers, or mobile phones.

The emitting unit 20 includes a number of IR emitters 21 and an emission controller 22. The IR receiving unit 30 includes a number of IR receivers 31 and a receiving controller 32. The IR emitters 21 and the IR receivers 31 are arranged by a predetermined order. The emission controller 22 and the receiving controller 32 are both connected to the processor 40. The IR emitters 21 are to emit IR beams 210 in sequence under the control of the emission controller 22, and the IR receivers 310 are to receive the IR beams reflected by an external object. In the embodiment, when an external object 70, such as a finger, is close to the surface of the display panel 50, the IR beam 210 will be reflected to a number of the IR receivers 30, and the IR receivers 30 receive the reflected IR beams 310 under the control of the receiving controller 32. The receiving controller 32 generates a number of response signals 320 corresponding to the reception of the IR receivers 30 and sends the response signals 320 to the processor 40.

The processor 40 includes an IR processing unit 41, a controlling unit 42, a display processing unit 43, and a storage unit 45. The storage unit 45 stores the corresponding coordinates of the IR emitters 20 and the IR receivers 30 on the display panel 50, and the functions corresponding to the coordinates of the IR emitters 20 and the IR receivers 30. The IR processing unit 41 receives the response signals 320, and determines a virtual position of the object 70 on the display panel 50. In the embodiment, the virtual position is the position of a touch point (not labeled). The controlling unit 42 outputs a control signal according to the virtual position, and executes a corresponding function. The display processing unit 43 receives the control signal and updates the content on the display panel 50.

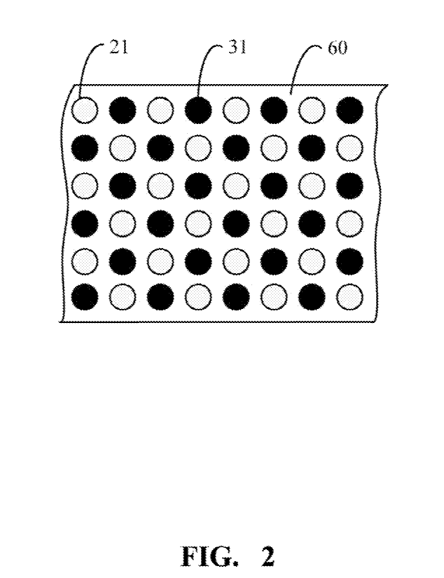

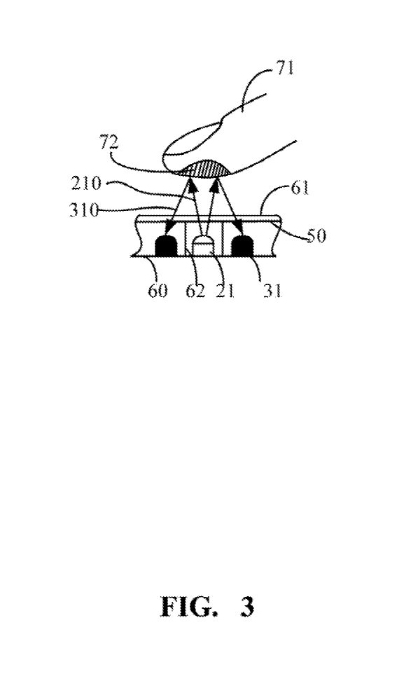

Referring to FIGS. 2-3, the IR emitters 21 and the IR receivers 31 are staggered on a circuit board 60. In the embodiment, each IR emitter 21 is adjacent to a number of IR receivers 31, and each IR receiver 31 is adjacent to a number of IR emitters 21. The IR receivers 31 receive the reflected IR beams 310 emitted by the IR emitters 21 and reflected by the finger 71. In the embodiment, while one of the IR emitters 20 is enabled to emit the IR beam 210 under the control of the processor 40, the processor 40 also enables the IR receivers 30 adjacent to the IR emitter 20.

The display panel 50 is arranged above the IR emitters 21 and the IR receivers 31, with the IR emitters 21 and the IR receivers 31 facing the display panel 50. The IR beams 210 and the reflected IR beams 310 can pass through the display panel 50. A transparent plate 61 is arranged above the display panel 50 to prevent the display panel 50 from being contaminated, or scratched. In order to avoid the IR beams 210 from being received directly by the IR receivers 31 without being reflected, in the embodiment, a light barrier 62 is arranged between the adjacent IR emitter 21 and IR receiver 31.

If the finger 71 is close to the surface of the display panel 50, the IR beam 201 emitted by the IR emitter 20 under the finger 71 is reflected, the IR receivers 30 adjacent to the IR emitter 20 receive the reflected IR beams 310. If there is no object close to the display panel 50, the IR beam 210 is not reflected, and the IR receivers 30 cannot receive any IR beam.

The IR processing unit 41 receives the response signals 320 corresponding to the IR receivers 30 being enabled, and determines whether the strength of the response signals 320 reach a predetermined threshold. If the strength of one or more of the response signals 320 reaches the predetermined threshold, the IR processing unit 41 determines that a touch point is created. The IR processing unit 41 then reads the corresponding coordinates of the IR receivers 30 stored in the storage unit 45, and determines the position of the touch point according to the coordinates and the strengths of the response signals of the IR receivers 30. The controlling unit 42 outputs a control signal according to the position of the touch point, and executes a corresponding function.

In other embodiments, the IR controlling device 100 includes a program allowing the user to input commands with different gestures. For example, when the finger moves above the display panel 50, such as up-slip, down-slip, left-slip or right-slip, the IR processing unit 41 determines the gesture according to the positions of a series of consecutive touch points. The controlling unit 42 executes a function corresponding to the gesture.

In another embodiment, a number of icons (not labeled) are displayed in the display panel 50, and the position of each icon corresponds to that of one or more IR emitters 20 and IR receivers 30. The storage unit 45 stores a number of functions corresponding to the icons. When the object 70 stays above one of the icons, the IR beams emitted by the IR emitters 20 corresponding to the icon are reflected to the corresponding IR receivers 30. The IR processing unit 41 determines the position of the icon, and then reads the corresponding function of the icon stored in the storage unit 45. The controlling unit 42 executes the function corresponding to the icon.

For example, the function of one of the icons can be predetermined to turn on/off the IR controlling device 100 if the object 70 stays above an icon for a first/second time period, or adjust the volume if the object 70 is close to or away from the icon.

In another embodiment, in order to avoid other objects, such as the other fingers of the user reflecting the IR beam 210, and interfering with the user's real operation, a reflection device 72 has a reflection higher than the reflection of skin can be worn on the operating finger 71. The receiving sensitivity of the IR receivers 30 can be adjusted, such that, the strength of the IR beams reflected by the finger 71 cannot reach the reception threshold of the receivers 30, and the IR receivers 30 can only receive the IR beams reflected by the reflection device 72.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An IR controlling device comprising:
a display panel;
a plurality of IR emitters and a plurality of IR receivers staggered under the display panel and facing the display panel, wherein the IR emitters are to emit IR beams in sequence, and the IR receivers are to receive the IR beams reflected by an external object;
a receiving controller generating a plurality of response signals corresponding to the reception of the IR receivers; and
a processor comprising:
an IR processing unit configured for receiving the response signals, and determining a virtual position of the external object on the display panel;
a controlling unit configured for outputting a control signal according to the virtual position, and executing a corresponding function; and
a display processing unit configured for receiving the control signal and updating the content on the display panel.

2. The IR controlling device as described in claim 1, wherein while one of the IR emitters is enabled to emit the IR beam, the processor also enables the IR receivers adjacent to the IR emitter.

3. The IR controlling device as described in claim 1, wherein the IR emitters and the IR receivers are arranged by a predetermined order.

4. The IR controlling device as described in claim 3, wherein the processor further comprises a storage unit storing the corresponding coordinates of the IR emitters and the IR receivers on the display panel, and the functions corresponding to the coordinates of the IR emitters and the IR receivers.

5. The IR controlling device as described in claim 4, wherein when a strength of one or more of the response signals corresponding to the IR receivers being enabled reaches a predetermined threshold, the IR processing unit reads the corresponding coordinates of the IR receivers stored in the storage unit, and determines the virtual position of the object according to the coordinates and the strengths of the response signals of the IR receivers.

6. The IR controlling device as described in claim 1, further comprising a transparent plate arranged above the display panel to prevent the display panel from being contaminated, or scratched.

7. The IR controlling device as described in claim 1, further comprising a light barrier arranged between the adjacent IR emitter and IR receiver.

8. An IR controlling device comprising:
a reflection device;
a display panel;
a plurality of IR emitters and a plurality of IR receivers staggered under the display panel and facing the display panel, wherein the IR emitters are to emit IR beams in sequence, and the IR receivers are to receive the IR beams reflected by the reflection device;
a receiving controller generating a plurality of response signals corresponding to the reception of the IR receivers; and
a processor comprising:
an IR processing unit configured for receiving the response signals, and determining a virtual position of the reflection device on the display panel;
a controlling unit configured for outputting a control signal according to the virtual position, and executing a corresponding function; and
a display processing unit configured for receiving the control signal and updating the content on the display panel.

9. The IR controlling device as described in claim 8, wherein while one of the IR emitters is enabled to emit the IR beam, the processor also enables the IR receivers adjacent to the IR emitter.

10. The IR controlling device as described in claim 8, wherein the IR emitters and the IR receivers are arranged by a predetermined order.

11. The IR controlling device as described in claim 10, wherein the processor further comprises a storage unit storing the corresponding coordinates of the IR emitters and the IR receivers on the display panel, and the functions corresponding to the coordinates of the IR emitters and the IR receivers.

12. The IR controlling device as described in claim 11, wherein when a strength of one or more of the response signals corresponding to the IR receivers being enabled reaches a predetermined threshold, the IR processing unit reads the corresponding coordinates of the IR receivers stored in the storage unit, and determines the virtual position of the object according to the coordinates and the strengths of the response signals of the IR receivers.

13. The IR controlling device as described in claim 8, further comprising a transparent plate arranged above the display panel to prevent the display panel from being contaminated, or scratched.

14. The IR controlling device as described in claim 8, the reflection device having a reflection higher than the reflection of skin, wherein the reflection device can be worn on an operating finger of a user.

15. The IR controlling device as described in claim 8, further comprising a light barrier arranged between the adjacent IR emitter and IR receiver.
